(19) United States
(12) Patent Application Publication
(10) Pub. No.: US 2008/0137554 A1
(43) Pub. Date: Jun. 12, 2008

(54) Method Of Geographicallly Locating Network Addresses Incorporating Probabilities, Inference And Sets

(75) Inventor: Ian R. Nandhra, Sonora, CA (US)

Correspondence Address: BEYER WEAVER LLP, P.O. BOX 70250, OAKLAND, CA, 94612-0250, US

(73) Assignee: FINDBASE LLC, Twain Harte, CA (US)

(21) Appl. No.: 11/721,804

(22) PCT Filed: Dec. 19, 2005
(86) PCT No.: PCT/US05/45949

§ 371 Date: Jun. 14, 2007

Related U.S. Application Data
(60) Provisional application No. 60/637,071, filed on Dec. 17, 2004.

(51) Int. Cl. H04L 12/28

(52) U.S. Cl. 370/254

(57) ABSTRACT

Method for geographically network equipment on a communications network, such as the Internet, using communication times to and from the network equipment to be located. Communication time measurements are taken from measuring stations on the network to the equipment to be geographically located and also to other locations of known and unknown location. The probability of the network timing characteristics from the measuring stations to the equipment to be located being most similar to the network timing characteristics of said measuring stations to other equipment of know location is calculated to determine the geographical locations having the highest probability of being proximate to the equipment to be located.

### BACKGROUND OF THE INVENTION

“IP addresses” are used to uniquely identify a particular device on networks such as the Internet from other devices on the network. IP addresses are unique, but might not be directly related to any specific user. For example, the IP address from which a user accesses the network might be different each time he accesses to the network even when the geographic location of the user himself has not changed.

The anonymity the Internet provides makes identification of who is using an IP address and the geographic location of the user very difficult. While some consider this anonymity to be an integral part of personal privacy, others, such as financial institutions, would like to identify the geographic location of users as a tool to combat fraud.

There are many advantages of identifying the geographical or physical location of a unique device or user connected to a network. For example, financial institutions could provide enhanced security for transactions performed on networks if the geographical location of the user could be established (e.g. as another verification point to “authenticate” the user).

Geographical location (“geolocation”) technologies such as the popular Global Positioning System (GPS) have been used for many years. Such systems typically require an electronic receiver intercepting signals from a number of transmitters in known locations. Examples of such transmitters include but should not be considered limited to stationary radio beacons, geo-stationary satellites and other transmitters moving in a predictive manner. Assuming that the transmitted signals traveled at a known speed, in a straight line or in a predictive manner and were unaffected by factors such as electromagnetic radiation and natural obstacles such as trees, the receiver could determine its location from the time taken to receive data from the transmitters. Other geographical location systems include sonar and radar such as can be found in military and aeronautical applications.

The techniques upon which such geolocation methodologies are based are unsuited to use in networks. Typically the distance between the interconnected devices is unknown, as is the time taken for a signal to be sent from a source to a specific destination. Network switching and routing elements can unpredictably vary the path data will take between a source and a destination.

Furthermore, the entry point to the network may not even correspond to the geographic location of the user. FIG. 1 shows an example of back-hauling typical of that found on the Internet. A user device physically located in Denver (102) is connected to an Internet Gateway 106 in Los Angeles through a DSL connection 104. Particular attention is drawn to network operations such as email and web browsing performed by device 102, which will appear to come from the connection point 106. Attempts to geographically triangulate the location of device 102 against fixed locations with predictive timing characteristics would result in device 102 appearing proximate to Los Angeles 106 since that is the entry point of device 102 to the Internet. Even if the distance between points 102 and 106 could be established, it would only establish an arc radius from points 100 to 108 due to the inability of device 102 to access any other known geographical point.

It may be possible for device 102 to perform other tests to determine its own physical location, but such tests would be specific to device 102 and not necessarily applicable to all devices in the network.

There are many products and services attempting to map or otherwise locate the geographical location of an IP address and such techniques suffer from numerous problems, including but not limited to:
1. Users in one geographical location using a phone or DSL system to connect to the network at a totally different geographic location in a process termed “back-hauling”.
2. There is no accurate directory that maps an IP's assigned owner to an organization.
3. There is no registry of what an IP's assigned owner is doing with an IP
4. IP addresses, assigned owners and usage locations may change very quickly and without notice.
5. Changes in networking topologies resulting in potentially large increases in unique network addresses. For example, the popular IPV4 standard on the Internet which provides for 2³² (4294967296) unique addresses is being replaced by the IPV6 standard that provides for 2¹²⁸ (3.4e+38) unique addresses which may easily be beyond the computational and storage limits for particular embodiments.

Attempts to identify the geographical location of an IP are rendered ineffective due to the lack of accurate information and the problems associated with disclosing information that could be considered by some parties to be personal and private or would be prohibited by applicable laws.

Registries of IP addresses to geographical locations exist, one such being www.arin.net but lack of guarantees as to the authenticity or accuracy of such information renders it virtually useless for purposes such as authenticating secure financial transactions. Errors and omissions in databases such as www.arin.net are commonplace and should be expected.

Networks typically include switching equipment and routers to direct data between source and destinations. Example connectivity between major Internet network providers and their hubs within the United States of America is shown in FIG. 2. While the network nodes and users within these topologies do sometimes change, the major hubs and distribution centers have a relatively slow rate-of-change. Using the public highway system in the United States of America as an analogy, it is uncommon, for example, to find that the interstate connections between Highways 5, 99, 88 and 80 in the Sacramento area of California have physically moved somewhere else. FIG. 2 shows an example layout of the routes, routers and hubs on the Internet by the number of routers, hubs and Network Providers should in no way be considered restricted to that shown in this example. In a practical network, the Internet being one example, the number of routers and hubs and their interconnections will vary over time. Routers and switching equipment are typically assigned an IP address that uniquely identifies them from other equipment connected to the network.

With reference to FIG. 3, we see interconnections between various locations in the southwestern quadrant of the USA where the lines interconnecting the locations take the form of varying speed and varying capacity network connections. Clearly, there are many ways in which each of the locations can communicate with another location. For example, location 300 can communicate with location 312 through a number of different paths, including: 300 to 302 to 304 to 312 and 300 to 306 to 308 to 312 and 300 to 302 to 306 to 310 to 308 to 316 to 314 to 312. The number of different connection paths between two locations will be dependent on the number and nature of the interconnections forming the paths. The length of the path (“as the crow flies”) between two locations should not be considered to be an indication of the time for communication between the two locations. For example, the path between 300 and 302 is shown as a direct (or straight) line whereas the actual communication medium, such as fiber optic or copper cable, would likely take a longer distance to, for example, traverse obstacles between the locations. Network switching and routing equipment situated between locations such as for example 300 and 302 introduce unpredictable delays (often called “propagation delays”) in the communication between the locations. Additionally, the number and nature of such switching and routing equipment may change over time. The time taken for a message to be sent from one location to another can be affected by many factors, such as (but not limited to):
1. the size of the communication
2. the bandwidth of the connection between the two locations
3. the prorogation delay of the connection between the two locations
4. the distance between the two locations.
   Thus, there is not a reliable correlation or relationship between the time a message takes from one location to another and the distance between the two locations rendering time-to-distance techniques potentially ineffective or inaccurate. One such time-to-distance technique described in United States patent publication 20020087666 (hereinafter referred to as “NGT”) suffers a number of significant problems when used on public networks such as the Internet. These problems can be summarized as, but should in no way be considered limited to:
1. Inability to communicate in particular directions on networks such as the Internet. For example, the network carriers and service providers (ISP's) frequently block the ability to utilize techniques such as ping and tracert to determine the round-trip time from one network device to another.
2. Network devices such as Personal Computers for security reasons typically block or are unresponsive to communications from techniques such as ping and tracert.
3. Network devices such as Personal Computers are frequently attached to networks behind devices performing Network Address Translation (NAT) or other techniques to hide the network device from visibility from other devices connected on networks such as the Internet. Such NAT networks can be extensive and part of large carriers such as America Online.
4. With specific attention to the NGT, the concept of Tₘᵢₙ and Tₘᵢₙ_{_{—}}_{abs} are only relevant for a duration of time specific to the network topology being used and are specific to particular network paths. Additionally, Tₘᵢₙ values and proximate values have to be periodically calculated, the frequency of which gives rise to problems. If the calculation frequency is too high, Tₘᵢₙ values might be unrepresentatively too high and conversely if the calculation frequency is too low, the Tₘᵢₙ values might be unrepresentatively too low.
5. With specific attention to the NGT, endpoint selection implies that the endpoint is capable of being pinged and that the endpoint doesn't move geographical locations. For example, equipment such as the web server of an ISP or a router for a network carrier can change physical locations at any time and without notice. Such fluctuations are a normal part of network topologies and should be expected. Although the frequency of such movements is typically small, the NGT lacks the ability to determine if a particular endpoint is located at its vetted geographical location at any given time. Failure to determine that an endpoint is actually where it is supposed to be will result in significant errors and inaccuracies.
6. The inability to ping, tracert or otherwise contact the network equipment to be geographically located will give rise to a complete inability to locate or serious problems in accurately determining its geographical location.

The problems of time-to-distance can be seen in FIG. 4 where a measuring device (404) at the geographical location of Phoenix (404) attempting to determine the time taken to communicate with a device at an “end point” in a geographical location Dallas (400) can communicate over a number of different paths, examples being, 404 to 422 to 418 to 400 and 404 to 418 to 400 etc. The number and nature of these paths will be dependant upon the specific topology of the network and should in no way be considered limited to this example. Since each of these paths could be of different physical length and will include propagation delays caused by the network equipment encountered along the path and the network loading, the time taken for a communication to reach 400 from 404 bears no reliable relationship to the actual physical distance between 400 and 404. Network switching equipment can route communications in unpredictable and often inconsistent ways and to assume that a minimum communication time measured between 404 and 400 is the shortest route overlooks that this is merely the shortest time on a specific possible connection and might not be the shortest physical path. For example, the path 404 to 400 might be the shortest physical path, but the switching equipment might continually route communications along the path 404 to 422 to 400. Assuming the encountered network equipment permit the identification of the paths taken between 404 and 400, successive communications measurements could yield a number of different paths each of which could have a communication time associated with the specific path. Furthermore, each specific path could be broken down into smaller components, or “hops”, allowing time for the communication between successive hops to be measured. Further information regarding the nature of the paths can be obtained if the points 404, 400, 418 and 422 were to take measurements against each other as shown in the interconnecting paths between 428, 424, 448 and 452. In instances such as on-line financial transactions where multiple measurements are not possible, the shortest time is merely the shortest time on a specific possible connection at a particular instant in time and repeated measurements might (and probably would) give rise to different results.

With reference to FIG. 5 we see Equipment To Locate “ETL” (514) bounded by locations 502, 524, 528 and it would be tempting to consider that if we know the time taken for a communication from 504 to ETL (514) we could determine the proximity of ETL (514) to 502, 524 and 528 if we knew the time taken from 504 to 502 and 504 to 524 and 528 to 522. However, this technique relies on knowing or being able to determine how ETL (514) is connected to the Internet and that station 504 can directly communicate with ETL (514). For example, if ETL (514) were connected via a private network to point 500, it is possible that the communication time from 504 to 500 would be shorter than for locations 502, 524, 528 giving rise to the incorrect determination that ETL was proximate to the location of 500.

Since certain types of communication to network equipment such as Personal Computers on the Internet are frequently blocked for security reasons it could, for example, be impossible for 504 to communicate with ETL 514 at all. Such problems can be circumvented if ETL (516) is able to communicate to other locations on the network and gather information about such communication.

With reference to FIG. 6, ETL (616) could attempt to geographically locate itself by using network path information gathered from communication with Station (604) and stations (602, 628 and 632). The connections from ETL (616) to the stations will be dependant upon factors such as but not limited to network topologies and network switching equipment and should not be considered restricted to the example in FIG. 6.

With consideration to the situation where ETL (616) is connected to the network via a private network (i.e. paths 612, 614, 624 and 626 do not exist), the measurements would be with reference to location 600 giving rise to potentially large inaccuracies in the absence of any other paths from ETL (616) to the network.

### BRIEF DESCRIPTION OF THE DRAWINGS

FIG. 1 An example of back-hauling

FIG. 2 Example Internet Map

FIG. 3 An example Map of Internet hubs and connections

FIG. 4 Example Network Topology

FIG. 5 Example “Equipment To Be Located” Topologies

FIG. 6 Example “Responsive Equipment To Be Located” Topologies

FIG. 7 Example connection time graph

FIG. 8 Minimum time calculations

FIG. 9 Locating an example ETL on a network

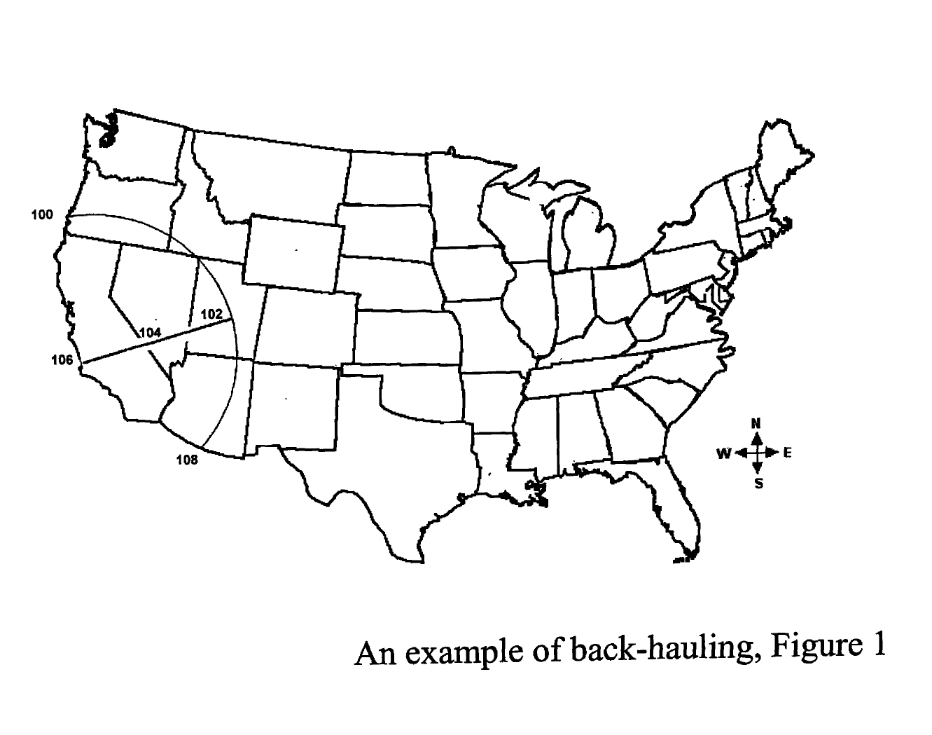

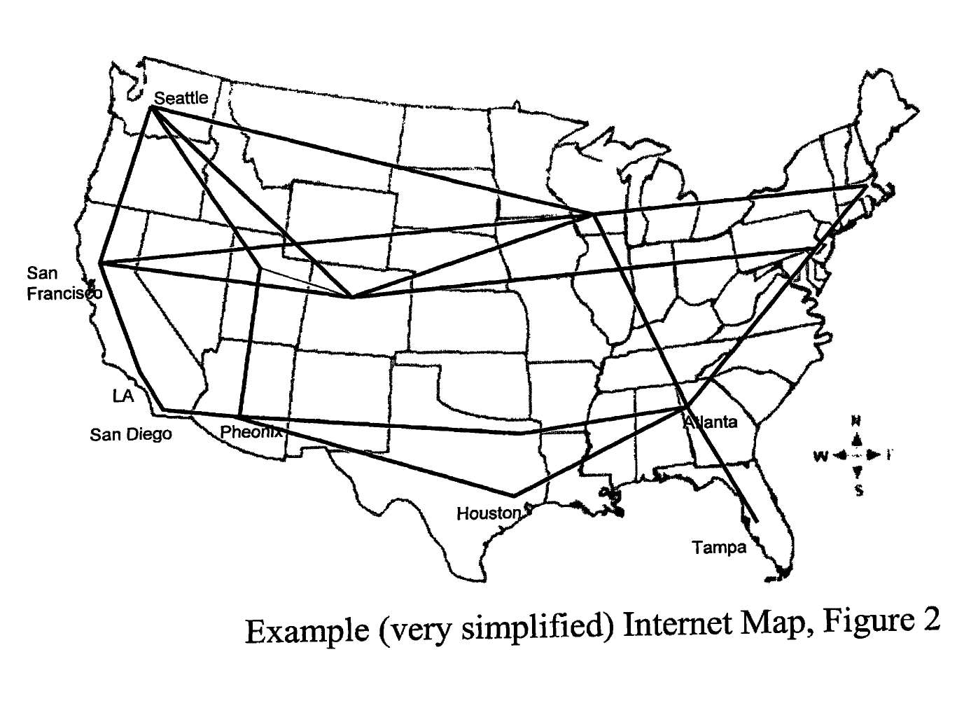

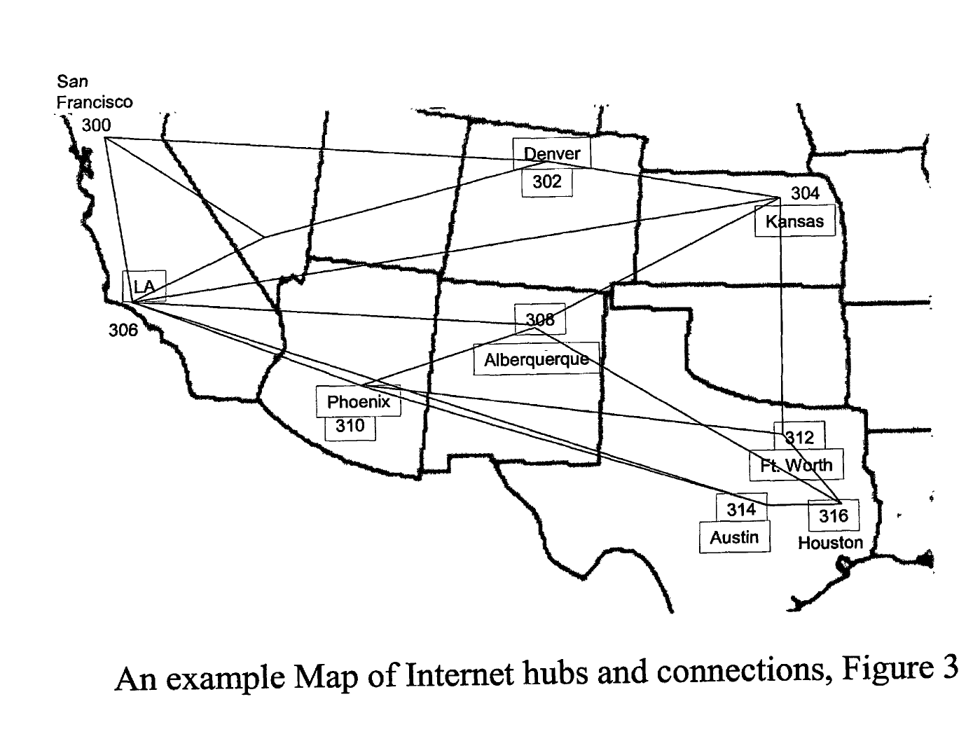

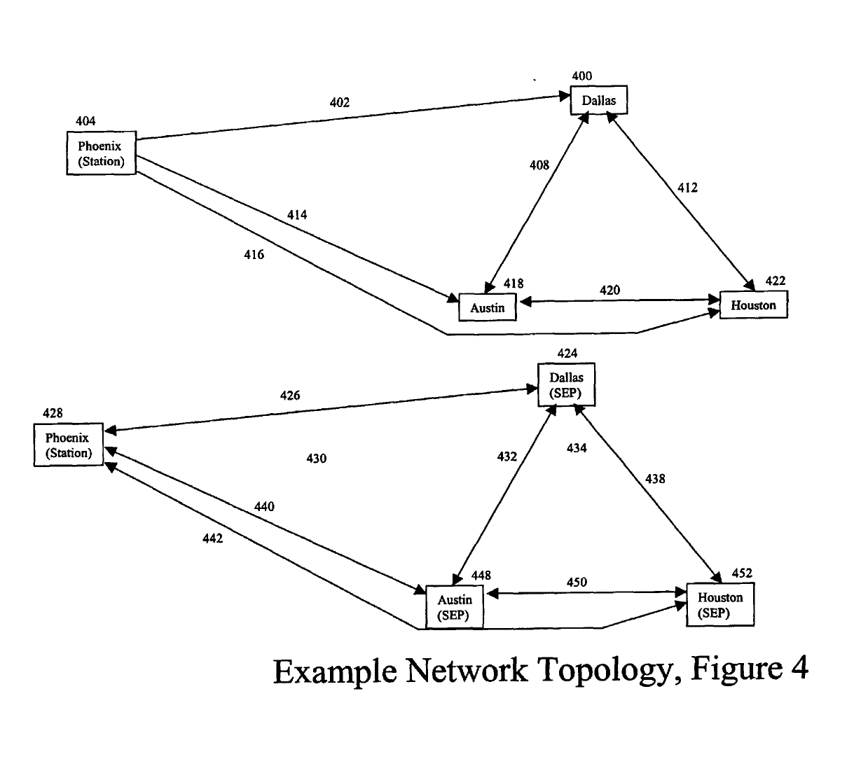

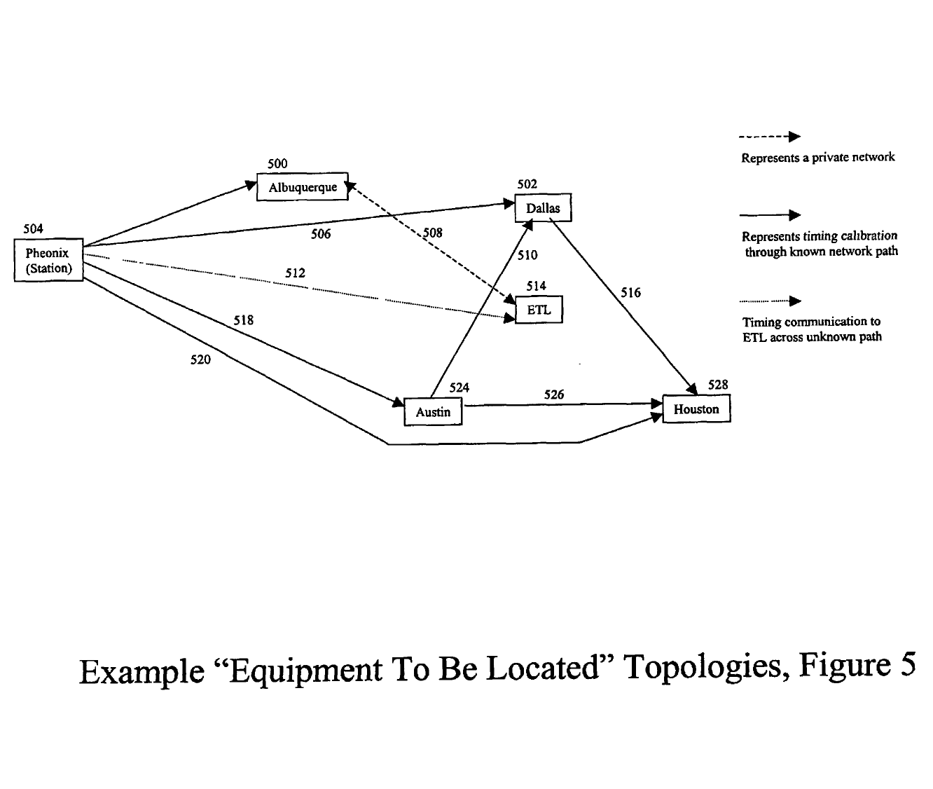

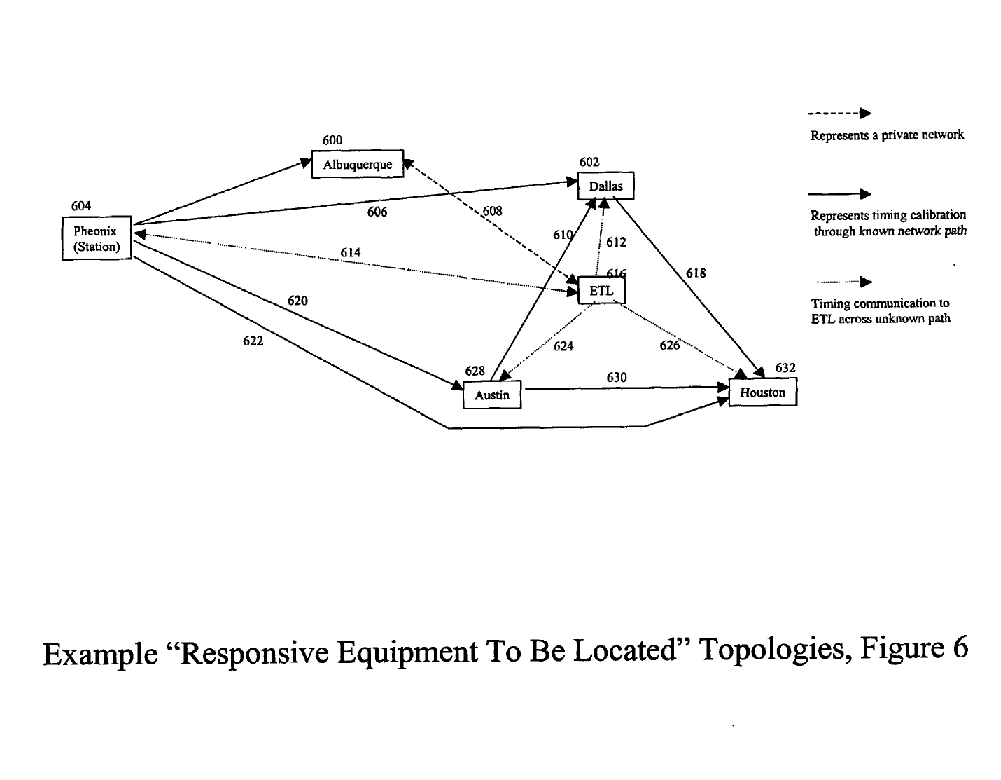

### DETAILED DESCRIPTION OF THE INVENTION

As used herein, the term “communication utility” (CU) is meant broadly and not restrictively, to include software, devices and techniques to establish a communication between a source and a destination and to determine characteristics such as the connection time for the network connection path. Examples of CU software include but are not limited to conventional “ping” and “tracert”. Another example would be connecting to devices such as “web servers” that use network paths that are considered “always open”, one such being “Port 80” as used in connection with the World Wide Web.

As used herein, the term ETL is meant broadly and not restrictively, to include equipment on a network the location of which is to be geographically located.

As used herein, the term “Active ETL” (AETL) is meant broadly and not restrictively, to include an ETL capable of gathering network path data from its location to a particular destination or a plurality of destinations. Such data may comprise but should in no way be considered limited to the time taken to establish communication between its location and a particular destination or destinations.

As used herein, the term “Passive ETL” (PETL) is meant broadly and not restrictively, to include an ETL which does not gather network path data from its location to a destination.

As used herein, the term “Responsive ETL” (RETL) is meant broadly and not restrictively, to include an ETL capable of responding to a communication from another network device. For example, such communications could be from but should in no way be considered limited to CU's such as “ping” and “tracert”.

As used herein, the term “Unresponsive ETL” (UETL) is meant broadly and not restrictively, to include an ETL incapable of (or just which does not) responding to a communication from another network device. For example, such communications could be from but should in no way be considered limited to CU's such as “ping” and “tracert” utilities

A particular ETL may possess any combination of AETL, RETL, PETL and UETL properties.

As used herein, the term “communication time” (CT) is meant broadly and not restrictively, to be the time taken to establish a communication between a source and a destination on a network and round-trip communication from source to destination and thence destination to source.

In accordance with one broad aspect, a mechanism is provided to construct sets of CT's between a single source location or plurality of source locations with respect to a single destination location or plurality of destination locations.

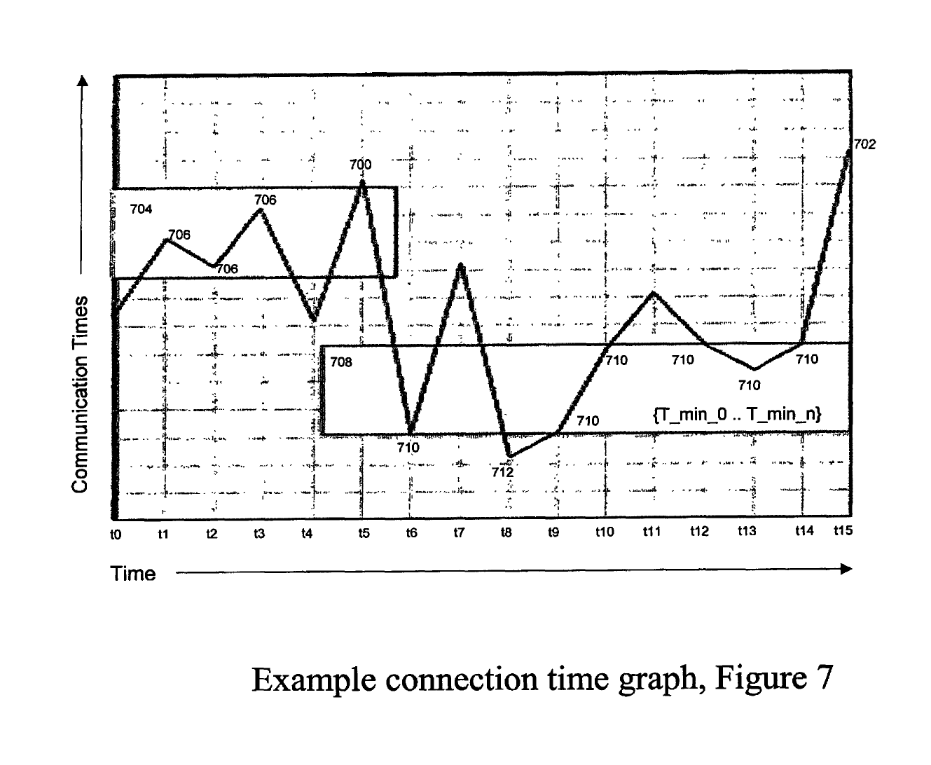

FIG. 7 depicts an example plot of communication measurement times comprising the set {t0 . . . t15} from a source location to a destination location on a network over time. Each point represents an individual communication, a plurality of communications between the source and destinations or a calculated value. In some examples, a value is the result of a calculation that can include all sorts of weighting values and/or could even be a probability resulting from larger calculations. There will be a maximum and minimum communication time that may be equal depending on the number and nature of the samples. The plot can also comprise further sets in accordance with the needs of specific embodiments and FIG. 7 shows a “maximal set” 704 comprising a plurality of the maximum values in the set {t0 . . . t15} and a “minimal set” 708 comprising a plurality of the minimum values in the set {t0 . . . t15}. The nature and magnitude of the values in sets 704 and 708 will vary between network paths and embodiments and should in no way be considered restricted to those shown in this example. The absolute minimum time Tₘᵢₙ_{_{—}}_{abs} (712) occurs at time t8 and represents the shortest communication time for all measurements in the set {t0 . . . t15} but not necessarily the shortest communication time for future time measurements t15+n or historically for time measurements t0−n where ‘n’ is a time interval. Some embodiments use Tₘᵢₙ_{_{—}}_{abs} as an indication of the shortest encountered communication path. A set may comprise contiguous measurements or non-contiguous measurements. A set of Contiguous Measurements (a “Contiguous Set”) are those which all fall into specific value range over a specific time range. For example, the measurements (710) for times t12, t13 and t14 form a Contiguous Set {t12 . . . t14) since they contain values (710) between the specific bounds Tₘᵢₙ_{_{—}}_{abs} and a value describing the upper range which encapsulates the value at t11 and t15 (702). A set of non-contiguous measurements (“Non-Contiguous Set”) comprise those that fall between an upper and lower bound over a number of time measurements. The Non-Contiguous Set (708) comprises communication times at the times {t6, t9 . . . t10, t12 . . . t14}. The communication times in the “maximal” non-contiguous set 704 represent the 4 highest times in the set {t0 . . . t15} not including the maximum time Tₘₐₓ_{_{—}}_{abs} (702). The values in the “maximal” set (704) can be used as a measure of reliability or unreliability of the communication. The number and value of the communication measurements comprising contiguous and non-contiguous sets is dependant upon specific embodiments and should in no way be considered limited to those shown in this example.

The shortest communication time for a path can be considered to be the lowest value of any given set of communication times. For example, 712 is Tₘᵢₙ_{_{—}}_{abs} in the set {t0 . . . t15} which is encountered less frequently than the next fastest times at t6 and t9 which in turn are less frequently encountered than those at t10, t12, t15. Furthermore, at time t14, it is unknown if the Tₘᵢₙ_{_{—}}_{abs} (712) accurately reflects the shortest possible communication time since the network path characteristics might have changed since T was measured. Furthermore, the value of Tₘᵢₙ_{_{—}}_{abs} may in fact be the result of some network path condition that may not reoccur with any regularity. Consequently the value of Tₘᵢₙ_{_{—abs}} is periodically determined either as the minimum value from a number of measurements or calculated from a number of measurements to form, for example, an average or probability. Particular attention is drawn to the length of time between the measurements from which Tₘᵢₙ_{_{—}}_{abs} is determined. A long time between measurements could result in minimal measurements being missed and a short time between measurements could be beyond the abilities of some embodiments and network topologies.

For the value of Tₘᵢₙ_{_{—}}_{abs} to be used as a measure of the fastest connection time when compared with another measurement implies or assumes that the network path characteristics are identical or similar for both measurements, which may not be the case. If a set of measurements contains many values that are frequently proximal to Tₘᵢₙ_{_{—}}_{abs} then there is an increased probability that the network characteristics are relatively unchanged since Tₘᵢₙ_{_{—}}_{abs} was measured.

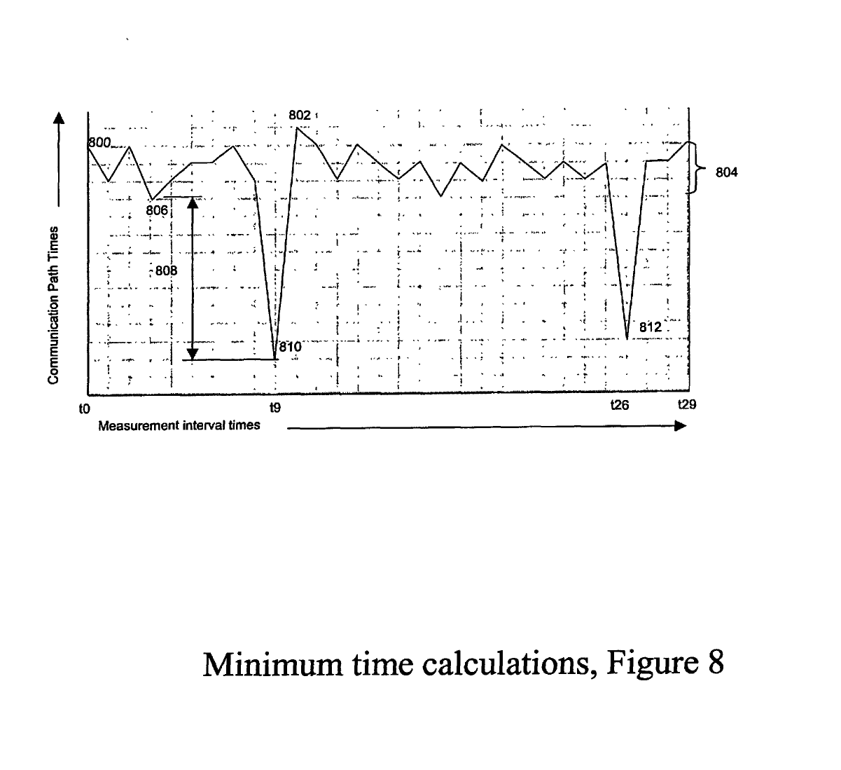

With reference to FIG. 8, we see a plot of network connection times (800) comprising a set {t0 . . . t29} measured at different measurement times (which may be at linear or non-linear regularity). The values in the range (804) that fall outside the “most maximal” and “most minimal” measurements or sets of measurements are considered to be the values that are most commonly measured. In the current example, the “most maximal” value is labeled 802 and the “most minimal” is labeled 810.

Particular attention is drawn to the Tₘᵢₙ values 810 and 812 at measurement times t9 and t26 respectively where 810 represents Tₘᵢₙ_{_{—}}_{abs}. The distance 808 between Tₘᵢₙ_{_{—}}_{abs} (810) and the bottom of the range (804) and between Tₘₐₓ_{_{—}}_{abs} (802) and the top of the range 804 can be used to determine the probability that Tₘᵢₙ_{_{—}}_{abs} is representative of the current network path characteristics. For example, if the distance 808 is large and/or the number of measurements in the set (804) that are non-proximal to Tₘᵢₙ_{_{—}}_{abs} is high, the probability that Tₘᵢₙ_{_{—}}_{abs} is repeatable is small. The relationship between the minimal values comprising the set {t9, t26} (810, 812) and set 804 can be used as an indication of such factors as network loading. Changes in the distance 808 can be used to determine the probability the network path characteristics have changed.

The network connection times (800) in the set {t0 . . . t29} can be individual measurements or a combination of measurements such as, for example an average or probability. For example, one embodiment uses the time taken to establish communication with a web server through Port 80 (a commonly “open” port on the Internet), another embodiment uses the time measurement from a tracert, another embodiment uses the average measurement from a ping and another embodiment uses a weighted average from a set of measurements (but the nature and scope of the measurements should be in no way considered necessarily limited to that described herein).

In order to locate an ETL (“Equipment To Locate” as discussed above) on a network, communication times are measured to and/or from the ETL and a station and compared with communication times from the aforementioned station to “end points” (EP's) in geographically known locations on the network. The probability that an ETL is proximate to a specific EP or plurality of EP's is determined from the comparison of the station to ETL and station to EP communication times. The granularity and accuracy is dependant upon factors such as, but in no way necessarily limited to the number of and location of the stations and the number and location of the EP's. Preferred embodiments will deploy a plurality of EP's and stations to provide the desired geographical coverage, granularity, network coverage and accuracy. Particular attention is drawn to the importance of ensuring that the EP's cover the network paths to potential ETL locations with respect to particular stations. More precise determination can be made if the EP's cover potential network paths to potential ETL's with respect to particular stations.

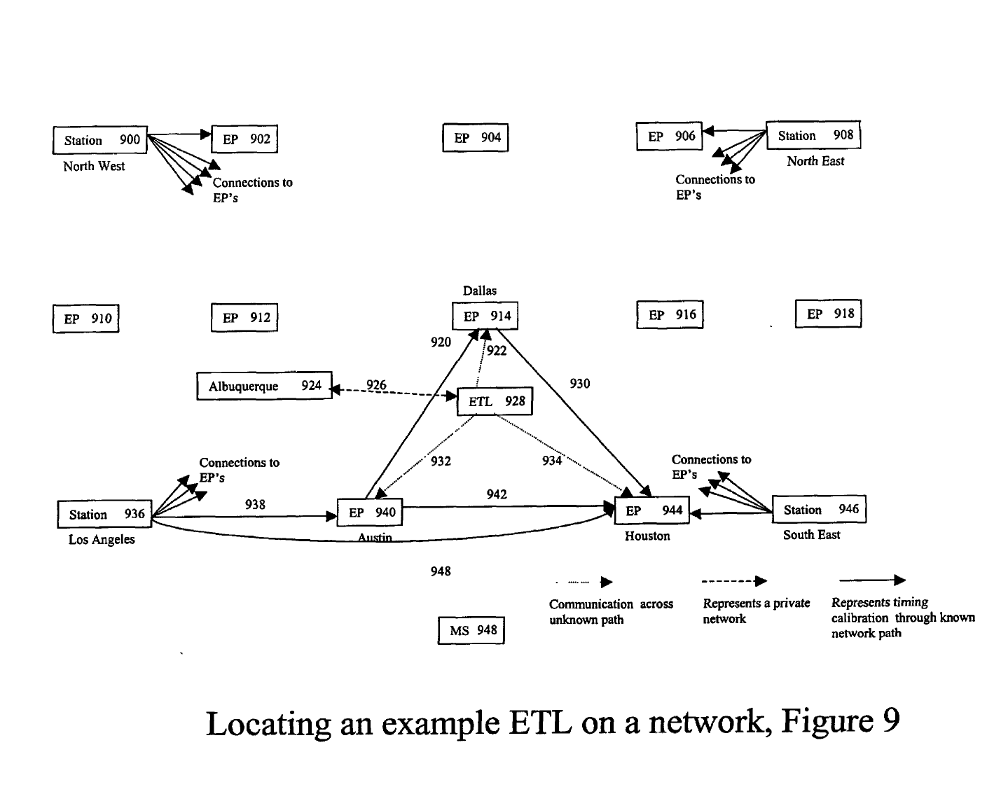

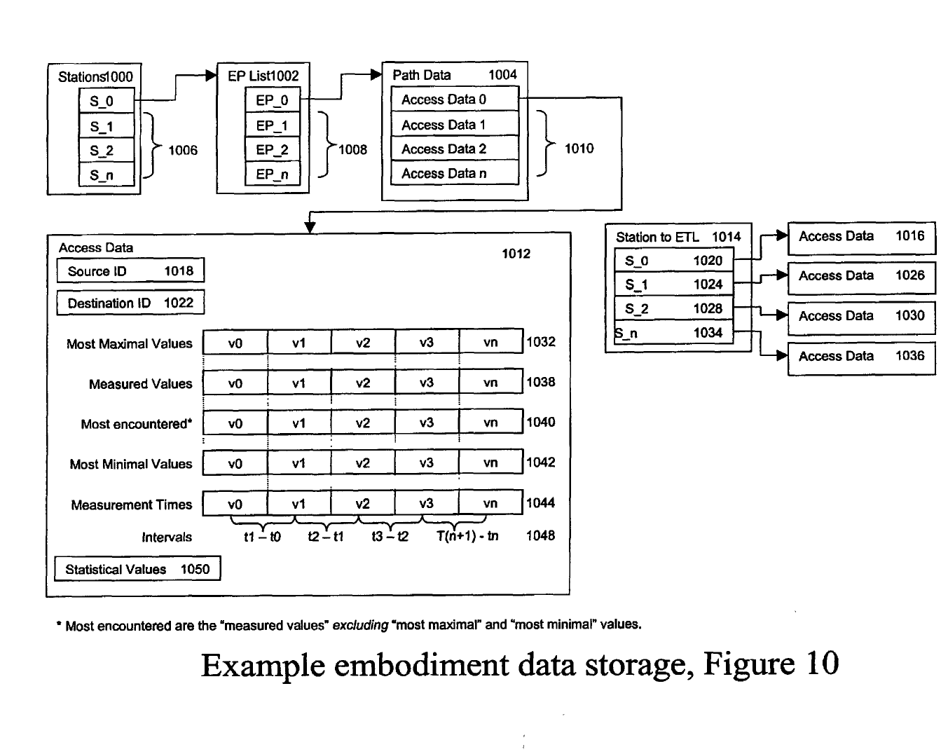

With reference to FIG. 9, Stations (900, 908, 936, 946), EP's in geographically known locations (902, 904, 906, 910, 912, 914, 916, 918, 940, 944), ETL (928) and Measuring Station “MS” (948) are connected to the same network. Stations (900, 908, 936, 946) are each capable of performing communication time measurements against any combination of EP's and any of the stations.

A MS (948) desiring to locate ETL (928) of known network address instigates a single station or plurality of stations (900, 908, 936, 946), to gather communication times from the respective station to the ETL. The manner in which the Stations communicate with ETL (928) is dependant upon the characteristics and properties of the network and the ETL. Since the precise network path and characteristics are unknown at the time a communication from a particular Station to ETL is made, there is no guarantee that the communication will reach the ETL. As previously discussed, the network topologies and ETL being located may block or otherwise be incapable of responding to communications generated by CU's such as “ping” and “tracert”. In the event that the network characteristics and/or ETL cannot directly respond to a communication, a particular Station will obtain no timing information and the ETL cannot be located with respect to that Station. In such circumstances embodiments use techniques such as “tracert” to attempt to identify the last network path from a particular Station to ETL (i.e, the path furthest the particular Station and closest to ETL) although there is no guarantee that the ETL is geographically proximal to the location of the last identified network location.

The timing information from a particular Station to ETL can take the form of an individual measurement or a plurality of measurements over a period of time appropriate to a specific embodiment. Some embodiments will take a plurality of measurements forming the set {t0 . . . tn}_{Sn→ETL} (where ‘Sn’ uniquely defines the Station) in a manner sufficient to generate plots similar to those previously discussed in FIGS. 7 and 8 respectively and preferably generating a load that only minimally or negligibly changes the characteristics of the network. The timing measurements in the sets {t0 . . . tn}_{Sn→ETL} from a single or plurality of Stations form the set {S0 . . . Sn}_{ETL} where the values of S0 . . . Sn are a sequence of Id's uniquely referencing the particular stations.

The timing measurements {t0 . . . tn}_{Sn→ETL} for each Station form the set {S0 . . . Sn}_{ETL} are then compared with the timing measurements from each Station to the each of the endpoints.

The probability of each Stn→ETL value in the set {S0 . . . Sn}_{ETL} being in the same path as each of the equivalent Stn→EP measurements is calculated and the Stn→EP with the highest probabilities are stored in a list. The nature of the calculation is dependant upon the specific embodiments. One example embodiment uses averages determine proximate values, another example embodiment uses Bayesian probability techniques and another example assigns a weight to newer measurements with respect to older measurements during averaging and probability calculations although the nature of the calculation should be in no way considered limited to the examples described herein.

Consider an example embodiment with four stations comprising a set {S0, S1, S2, S3} (the “Stations Set”) each station having timing measurements to an ETL comprising a set {S0 . . . S3} ETL (the “Station to ETL Set”) and each station having timing measurements against a set of ten Endpoints {E0, E1, E2, E3, E4, E5, E6, E7, E8, E9} in a set {E0 . . . E10}_{Sn} where Sn is the particular Station from the Stations Set.

The probability of the characteristics of each Station to ETL measurement in the Station to ETL set (for example, from Station S0 to ETL) being similar or proximate to each of the endpoints in the corresponding {E0 . . . E10}_{Sn} set (for example the {E0 . . . E10}_{S0} set) is calculated and stored in a results table.

Particular attention is drawn to the terms “similar” and “proximate”, the meaning of which can be extremely subjective and dependent upon the nature of particular embodiments. For example, an individual might find a person with “brown hair and green eyes” similar to a different person with “brown hair and blue eyes” but not similar to another different person with “blonde hair and green eyes”. In this example, the individual appears to place more emphasis on “brown hair” than on eye color. The choice could be influenced by personal preference of brown hair, a dislike of blonde hair or some other subjective factor. With respect to the term “proximate”, consider a numerical example in which the value 2.9999999999 could be considered proximate to 3.0 since the difference between them is very small (0.0000000001). However, if this is taken in the context of very small numbers, 0.0000000001 might represent a large difference. The term “proximate” implies that a range of values is known against which something can be compared, for example: 2.9 is proximate to 3.0 (±0.2) since (3.0−0.2)<2.9<(3.0+0.2), or 2.9 falls in the range 2.8 to 3.2 inclusive. Conversely 2.9 is not proximate to 3.0 if the range is 3.0 to 3.2 inclusive. The terms proximate and similar can in some examples be representations of each other. For example, 1.99 could be considered proximate to 1.999 and also similar because they both contain plurality of 9's, a numerical 1 and a ‘.’ character. Conversely, 1.999 could be considered proximate to 2.0 but the two numbers might not be considered similar. It can therefore be considered that “proximate” represents a value representing the ‘distance’ between items and ‘similar’ could be a representation of the commonality between items.

The EP's in the results table with the highest probabilities represent those where the network path characteristics are closest to the network path characteristics of the ETL. For example, there is a higher probability that the timing characteristics of the communication paths from Station 936 to EP's 940, 914, 944 (the set {E940, E914, E944}_{S936}) will be similar to that from Station 936 to ETL 928 because of the similarity in the network paths between Station S936, EP's 940, 914, 944 and ETL 928. Conversely, there is a lower probability that the timing characteristics of the communication paths from the stations (900, 908, 946) to EP's 902, 904, 906, 910, 912, 916, 918, 938 are similar to the timing characteristics of the communication paths from Stations (900, 908, 946) to ETL 928 because ETL 928 is not within the same network path proximity.

Various techniques used to compare the network path timing characteristics varies between embodiments. For example, one embodiment takes individual measurements or measurements of a small sample size between stations, endpoints and the ETL when the ETL needs to be located even though such measurements might not accurately reflect the true characteristics of the network over a longer period of time.

Another embodiment maintains a history of accesses between stations and endpoints that is used to identify and compensate for fluctuations in network characteristics.

Some embodiments maintain a history of previous accesses between Stations and Endpoints and where possible perform multiple accesses to the ETL and the EP's with the highest probability of being proximate to the ETL. For example, Station 936 measures the network path characteristics to ETL 928 and as previously discussed determines a list of those EP's having the highest probability of similar network path characteristics from a history of Station to Endpoint measurements. If for example, the network path characteristics between Station 936 and EP's 914, 944, 938, 912 have the highest probability, further measurements are taken between Station 936 and EP's 914, 944, 938, 912 and the probability of these network path characteristics is recalculated with respect to the network path characteristics between Station 938 and ETL 928, this process being repeated to determine an acceptable level of probability. Decreasing probability indicates that the network characteristic measurements have changed and the formerly “most probable” EP's are no longer the “most probable” and that EP's with previously measured probabilities need to be considered in the probability calculations. Some embodiments also include a weighting factor that gives decreasing value to older measurements over more recent measurements during measurement averaging and probability calculations since it is likely that a successive plurality of recent measurements is more reflective of the current network path characteristics than less recent measurements. For example, a plurality of chronologically recent measurements is more likely to be relevant than those from two months ago. Other weighting factors can be included such as, but in no way limited to, the rate-of-change of Tₘᵢₙ_{_{—}}_{abs} and Tₘₐₓ_{_{—}}_{abs}, the “maximal” and “minimal” sets (FIGS. 7 and 8 respectively) and the distance between the “most encountered” sets and the “minimal” sets and Tₘᵢₙ_{_{—}}_{abs}. Particular attention is drawn to embodiments that use a calculated or specific value of Tₘᵢₙ_{_{—}}_{abs} from a set of Tₘᵢₙ_{_{—}}_{abs} values taken over a period of time.

If all Stations in the Stations Set fail to obtain timing measurements to the ETL the ETL is deemed to be a UETL and geographic location is not possible unless the UETL possesses AETL properties. ETL's processing AETL properties can provide Station to ETL network communication times contacting the Station in the same way that the Station would contact an ETL with the additional step that information concerning the communication is transmitted from the ETL to the Station. Information received from AETL to Station communications is processed as previously described for Station to ETL communication.

Attention is now turned to an example embodiment where stations 900, 908, 936, 946 comprise a Stations Set {900, 908, 936, 946}ₛₜₙ (1000) and Endpoints 902, 904, 906, 910, 912, 914, 916, 918, 940, 944 comprise a Endpoint set {902, 904, 906, 910, 912, 914, 916, 918, 940, 944}ₑₚ (1002). Each station in the set { }ₛₜₙ (1000) measures the network path characteristics to each endpoint in the set { } ₑₚ (1002) at a plurality of times and performs operations to store the measured characteristics as “Access Data” 1012 as shown in FIG. 10. With further reference to FIG. 10, each station in the set { }ₛₜₙ (1000) has a vector of Endpoints (i.e. the set { }ₑₚ (1002)) each element in the vector referencing a “Path Data” vector (1004). Other stations (1006) refer to other EP vectors and other EP Vector elements (1008) refer to other Path Data vectors. Each member in the “path data” vector references “Access Data” (1012) that describes the network path characteristics of each of the encountered paths between the station and the endpoint and information to identify the path from source ID (1018) to destination ID (1022). A list of measured values (1038), most maximal values (1032) and most minimal values (1042) is maintained, each element in the list corresponding to the time of the measurement, “interval” (1048). Interval t0 represents the most recent measurement, t1 the next most recent and so on with interval tn representing the oldest. Correspondingly, most maximal (1032) value v0, the measured value (1038) v0 and the most minimal value v0 (1042) are the measurements made at time t0, values v1 are made at time t1 and so on with values vn being measured at tn.

It may be desirable for the measurements to be “linear,” although this is not necessarily a requirement. The linearity of the measurements (1044) can be inferred from the proximity between the intervals (1048) between successive measurements and may depend on the specific embodiment. For example, one embodiment may consider measurements made every hour with a range of +10 minutes and −4 minutes (i.e. the intervals are between 56 minutes and 70 minutes inclusive) to be “proximal” enough for the measurement times to be considered a linear series.

Examples of “most maximal” and “most minimal” sets can be seen in FIG. 7, (704 and 708 respectively) and it will be apparent that there will be fewer values in these sets than in the “measured values” set 1038. The “most encountered” values (1040) comprise the values in “measured values” (1038) excluding the “most maximal” and “most minimal”. The position of the values in these sets correspond to their respective measurement times t0, t1, t1 and so on.

Measuring Station MS 948 desiring to geographically locate ETL 928 initiates a single or plurality of stations in the set { }ₛₜₙ by, for example (but not limited to) a communication to a particular port on the appropriate station, to gather a single or plurality of communication times from the respective station to ETL 928 comprising a set { }_{stn→etl} (1014) of Access Data (1012), each member in the set { }_{stn→etl} (1014) representing a particular station from the set { }ₛₜₙ

The access data from the set { }_{stn→etl} (1014) is compared against the corresponding stations EP measurement values ({ }ₑₚ (1002)) from the { }ₛₜₙ (1000) such that the Stn→ETL access data from station 0 is compared with the EP (1002) values for station 0 from the { }ₛₜₙ set (1000) and repeating for stations 1, 2 and so on until all the corresponding stations from the { }_{st→etl} (1014) set have been compared with their equivalents in the { }ₛₜₙ set (1000).

In the present example, Access Data from a Station to ETL (ETL_{ad}) is compared to the Access Data from (the corresponding) Station to EP (STNₑₚ) by determining the proximity of the measured values, most maximal values and most minimal values of the ETL_{ad} against the corresponding “most encountered” values (i.e. 1040), most maximal values and most minimal values in the STNₑₚ given that such STNₑₚ values can be subject to a range above and or below their specific values. In this present example, the ETL_{ad} comprises a single measurement but there is no reason why, for added accuracy ETL_{ad} could not contain a plurality of measurements. The EP's that are considered “most proximal” are those possessing values that fall within a particular range with respect to corresponding values in ETL and these EP's form a list in order of “most proximal” to “least proximal”. The definition of “most proximal” may vary between embodiments, but the present example performs the operations:

The proximity of ETL_{ad} with respect to STNₑₚ is represented by p(S|T)

A value is X is considered “in range” to a value Y if it satisfies the condition:

(Y−lower range)<=X<=(Y+upper range)

and “outside range” if it fails the condition

The upper and lower ranges can be any value including zero.

The set { }ₙₒᵣₘ contains the measured values excluding the “most maximal” and “most minimal” values. If ‘norm_mean’ represents the mean of the values in { }ₙₒᵣₘ and σₙₒᵣₘ represents the standard deviation of the values in { }ₙₒᵣₘ, then ETL_{ad} is not proximal to STNₑₚ if:

ETLₙₒᵣₘ_{_{—}}ₘₑₐₙ is outside of the range STNₑₚ_{_{—}}ₙₒᵣₘ_{_{—}}ₘₑₐₙ+/−range

ETL_{σ}_{_{—}}ₙₒᵣₘ is outside of the range STNₑₚ_{_{—}}ₙₒᵣₘ_{_{—}}+/−range

In the situation where the ETL contains one measured value, a simpler test to determine if the value fell between the upper and lower values in STNₑₚ { }ₙₒᵣₘ.

ETL_{ad} may also not be considered proximal to STNₑₚ if ETL_{mostMax} falls outside a range of STNₑₚ_{_{—}}_{mostMax} values and if ETL_{mostMin} fall outside a range of STNₑₚ_{_{—}}_{mostMin} values.

The proximal values for p(S|T) where S represents ETL_{ad} and T represents STNₑₚ include the range values from the range tests and in preferred embodiments values representing the age of the STNₑₚ values. For example, if ETLₙₒᵣₘ_{_{—}}ₘₑₐₙ is within the range STNₑₚ_{_{—}}ₙₒᵣₘ_{_{—}}ₘₑₐₙ+/−range, the distance (ETLₙₒᵣₘ_{_{—}}ₘₑₐₙ−STNₑₚ_{_{—}}ₙₒᵣₘ) would be an indication of how proximal ETLₙₒᵣₘ_{_{—}}ₘₑₐₙ is to STNₑₚ_{_{—}}ₙₒᵣₘ.

The p(S|T) values defining the proximity of ETL to STNₑₚ are stored in a “results vector” where the elements are sorted in order of “most proximal” to “least proximal”. In the present example, “most proximal” is defined as decreasing values of p(ETLₙₒᵣₘ_{_{—}}ₘₑₐₙ|STNₑₚ_{_{—}}ₙₒᵣₘ_{_{—}}ₘₑₐₙ) but should in no way be considered limited to this example.

The age of the measured values (i.e. tn−t0) and the interval values (1048) affects the chronological validity (but not necessarily the accuracy) of the results. For example, a higher proportion of older station to EP measurements with respect to newer measurements increases the probability that the results were valid at a previous time. Conversely, a higher proportion of more recent station to EP measurements with respect to older measurements increases the probability that the results will be less historical and more “current”.

Attention is drawn to the station set { }ₛₜₙ where the number of stations can increase the number of times that an a particular EP is added to the results vector thusly increasing the accuracy of the probability that the particular EP is proximate to the ETL (and conversely that the ETL is proximate to the particular EP).

In situations where the a single or plurality of stations cannot communicate with an ETL (i.e it has UETL properties), the ETL may perform the communications to the stations in response to a command or request from the stations or as part of the internal operation of the ETL and the measured values are calculated as previously described. In situations where the communication utilizes one of the open ports on the Internet (such as port 80 to, for example, a web server), the communications times might include an increased latency for the web server to respond and other latencies resulting from the topology of the network path being traversed. In such instances, the average of a plurality of measurements can be used to represent a communication measurement noting that some embodiments may remove “outlander” measurements to reduce the variance (e.g. standard deviation ‘σ’) of the values being averaged.

In summary we have described a system that can be used for determining the probability of geographical origin of a networked device or a network address in a networked environment. The usefulness of the present invention extends beyond the financial services example described herein to other applications such as Law Enforcement, Government Security and identification of where people are on a network are possible although the scope of applications and specific embodiments should in no way be considered restricted to those described.

The following is provided as a guide to some of the subject matter that we consider to be inventive aspects. Of course, the listing here is intended to be a partial list, since the “invention” is defined by the claims of a subsequent non-provisional patent application claiming priority to this provisional patent application.
1. The technique whereby the ETL communicates with the stations and EP's. This different from the NGT
2. The technique perform communications are performed to PORT 80 and, as appropriate, there is compensation for the extra latencies involved. It is noted that while it is theoretically slower on PORT 80 than for (say) a ping, this isn't always the case. The use of sets described above average out the differences or reduce them to an insignificant amount. The NGT specifically uses ping and tracert.
3. The use of sets of “most maximal”, “most minimal” etc. (The NGT is entirely reliant on the fastest measured time, T_min_abs whereas the described examples are not necessarily interested in the absolute minimum, but rather, are most interested in what is happening most currently.)
4. The use and consideration of a value for the age of the data being used.

What is claimed is:

1. A method of predicting an actual location of equipment to locate (ETL) connected to a network of a plurality of nodes, comprising:
observing messages from the ETL to at least a portion of the nodes; and
processing characteristics relative to the observed messages to predict an actual location of the ETL.

2. A method of measuring a rate of change of a location of equipment to locate (ETL) connected to a network of a plurality of nodes, comprising:
at a plurality of different times, observing messages from the ETL to at least a portion of the nodes; and
processing characteristics relative to the observed messages to characterize a change of location of the ETL, with respect to a topology of the network.
